(19) United States
(12) Patent Application Publication
(10) Pub. No.: US 2006/0225020 A1
(43) Pub. Date: Oct. 5, 2006

(54) Methods and apparatus for 3-D FPGA design

(76) Inventors: Anantha Chandrakasan, Belmont, MA (US); Young-Su Kwon, Cambridge, MA (US); Payam Lajevardi, Cambridge, MA (US); Francis A. Honore, Cambridge, MA (US); L. Rafael Reif, Newton, MA (US); Donald E. Troxel, Belmont, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/097,363

(22) Filed: Apr. 1, 2005

(51) Int. Cl. G06F 17/50

(52) U.S. Cl. 716/17

(57) ABSTRACT

Methods, apparatus, and systems are directed to an FPGA that includes a three-dimensional architecture having a component coupled to at least five components across two or more strata. In one embodiment, a FPGA includes a three dimensional switch that can be coupled to at least the five switches, wherein switches are located on first and second stratum. In another embodiment, slice instances are placed in inter-stratum and intra-stratum stages.

### STATEMENT REGARDING FEDERALLY SPONSORED RESEARCH

The Government may have certain rights in the invention pursuant to DARPA Contract No. N66001-04-C-8032.

### CROSS REFERENCE TO RELATED APPLICATIONS

Not Applicable.

### BACKGROUND

As circuit technology scales, the costs of chip-fabrication increase rapidly. Field Programmable Gate Arrays (FPGAs) can be a cost-effective alternative to Application Specific Integrated Circuits (ASICs) for many systems. The implementation of systems on FPGAs has the advantage of shorter time-to-market as compared with ASIC implementations. In addition, a system having FPGAs can be tested and debugged repeatedly in a shorter period of time at a lower cost compared to ASIC implementations.

Some FPGAs, such as those from Xilinx corporation, have two-dimensional arrays of tiles having configurable logic blocks (CLBs) and switches. The switches have programmable interconnection points (PIPs) to enable connection to the four adjacent switches on 2-D array. Connecting elements in a 2-D FPGA is well known in the art.

Since the speed and density of FPGA chips increase with technology, the application area of FPGAs, which was previously limited primarily to system prototyping, has been extended to higher performance and more complex custom applications. However, FPGAs are slower and power-inefficient than ASIC systems because the speed of internal FPGA interconnects do not scale with technology. The speed and energy consumption of FPGAs are dominated by element interconnects. The speed of FPGAs is also limited by the delay of long wires and buffers and the energy consumption is limited by the larger capacitance of wires and programmable interconnects.

### SUMMARY

The present invention provides methods and apparatus for a three-dimensional (3-D) Field Programmable Gate Array (FPGA). In general, components of the FPGA, e.g., 3-D switches, programmable logic blocks (PLBs), and slices (e.g., look-up table, flip-flop), are interconnected to reduce wiring distance and thereby provide more efficient energy consumption as compared to conventional FPGA architectures.

In one aspect of the invention, embodiments of the invention can include one or more of the following features: Designing an FPGA, in a three dimensional array of tiles having respective switches, by connecting a first switch in a first tile in the array of tiles to one or more of at least five other switches in the array of tiles nearest, in one embodiment, to the first tile across first and second strata of the array. Coupling the first switch to one of the at least five other switches using an inter-strata via. The structure for a first wire of the first switch includes four intra-stratum connections and one or more inter-strata connections. Reducing wire-length as a parameter to route and place components in the FPGA. Using simulated annealing to place slices. Performing intra-strata optimization. Using a center of gravity for slices coupled to a net coupled to a selected instance of a slice. Performing an available location search in an inter-strata spiral. Performing power-driven placement. Locating instances having a higher switching activity on a strata close to a heat sink. Partitioning the FPGA to collocate elements for a tile including a PLB, switch, and configuration memory. Partitioning the FPGA to alternate support strata and core strata. Partitioning the FPGA to place PLBs on a first strata and switch blocks on a second strata.

In another aspect of the invention, an FPGA device can include one or more of the following features: A three dimensional (3-D) array of tiles each having a 3-D switch and a PLB, wherein a first one of the switches in the array of tiles can be coupled to at least five other ones of the switches in the array of tiles across first and second or more strata. The first one of the switches includes a number of configurable interconnection points equal to fifteen times the number of wires per channel. Pins of the PLB are connected to wires, wherein a structure for a wire connection includes four intra-stratum connections and two inter-stratum connections. The FPGA is partitioned. The FPGA is partitioned based upon one or more of tile element collocation, support and core stratum, PLB stratum and switch stratum, and alternating stratum.

In another aspect of the invention, a CAD system includes one or more of the following features. A processor coupled to a memory, an operating system, and a CAD application having a placement module and a routing module. The memory can store instructions that when executed enable one or one or more of the following. Designing an FPGA, in a three dimensional array of tiles having respective switches, by connecting a first switch in a first tile in the array of tiles to one or more of at least five other switches in the array of tiles nearest to the first tile across first and second strata of the array. Coupling the first switch to one or more of the at least five other switches using an inter-strata via. The structure for a first wire of the first switch includes four intra-stratum connections and one or more inter-strata connections. Reducing wire-length as parameter to route and place components in the FPGA. Using simulated annealing to place slices. Performing intra-strata optimization. Using a center of gravity for slices coupled to a net coupled to a selected instance of a slice. Performing an available location search in an inter-strata spiral. Performing power-driven placement. Locating instances having a higher switching activity on a strata close to a heat sink. Partitioning the FPGA to collocate elements for a tile including a PLB, switch, and configuration memory. Partitioning the FPGA to alternate support strata and core strata. Partitioning the FPGA to place PLBs on a first strata and switch blocks on a second strata.

### BRIEF DESCRIPTION OF THE DRAWINGS

The exemplary embodiments contained herein will be more fully understood from the following detailed description taken in conjunction with the accompanying drawings, in which:

FIG. 1 is a schematic depiction of a portion of a 3-D FPGA in accordance with the present invention;

FIG. 2 is a schematic representation of a 3-D switch architecture for a wire;

FIG. 3 is a block diagram of an exemplary workstation having a CAD application to design 3-D FPGAs;

FIG. 4 is a pictorial representation of a technique for slice placement;

FIG. 5 is a pictorial representation of a difference vector technique;

FIG. 6 is a pictorial representation of a technique for available location searching;

FIG. 7 is a pictorial representation of a technique for power-driven 3-D placement;

FIG. 8 is a schematic depiction of a partitioned 3-D FPGA;

FIG. 9 is a schematic depiction of a configuration-partitioned 3-D FPGA;

FIG. 9A is a schematic depiction of a partitioned 3-D FPGA; and

FIG. 10 is a schematic depiction of a switch-partitioned 3-D FPGA.

### DETAILED DESCRIPTION

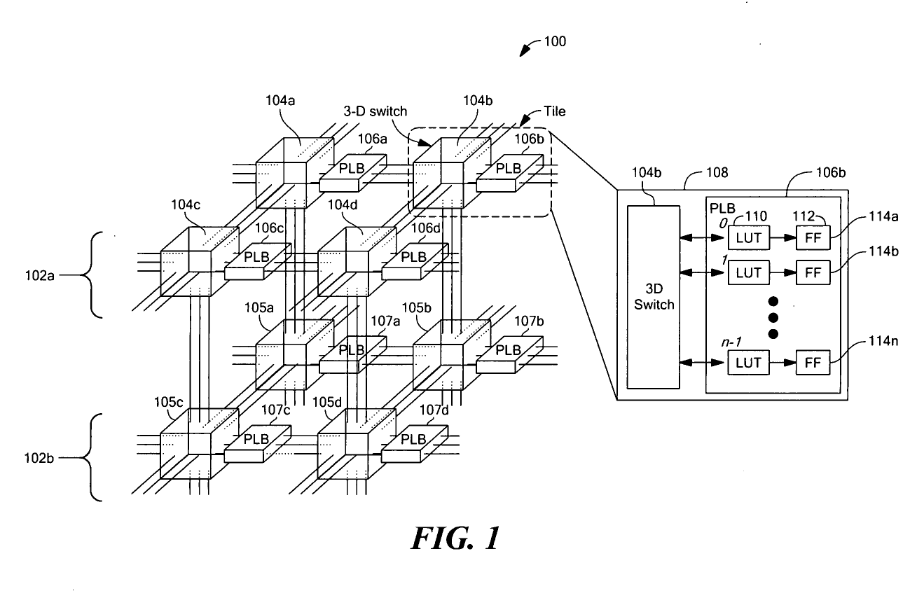

FIG. 1 shows a portion of an exemplary FPGA 100 having a 3-D architecture in accordance with the present invention. The FPGA 100 includes a series of strata 102a, b (first and second stratum are shown) each comprising 3-D switches 104a-d (first stratum 102a), 105a-d (second stratum 102b) having associated programmable logic blocks (PLB) 106a-d, 107a-d. In one particular embodiment, a stratum refers to a SOI (Silicon-on-Insulator) wafer, which has the geometry of a planar area. Multiple SOI wafers can be bonded through oxide or Copper. It is understood, however, that the strata can be formed using a variety of other suitable materials and processes, such as bulk.

In an exemplary embodiment, a tile 108 in the 3-D FPGA 100 includes a 3-D switch 104b and a PLB 106b. A 3-D mesh array of tiles 108 constitutes a FPGA where wires of each 3-D switch 104 are connectable to that of nearest six switches (four sides, top and bottom), for example, for a 3-layer embodiment. For the top and bottom strata, each switch shares wires with the nearest six switches. A two-layer (first and second strata) embodiment can have a switch connectable to five other switches and a three-layer (first, second, and third strata) embodiment can have a switch connectable to six other switches.

The tiles 108 in the 3-D FPGA include a 3-D switch 104 and a PLB 106. In one particular embodiment, the PLB 106 includes a pair formed from a LUT (Look-Up-Table) 110 and a FF (flip-flop) 112, which can be referred to as a slice 114a. A PLB is composed of n slices 114a-n, which are coupled to the 3-D switch 104. It is understood that slice should be construed broadly and is not intended to denote any particular architecture.

It is understood that the PLB can be formed using structures and techniques other than the illustrated slices, LUTs, and particular switch circuits. It is further understood that slice should be construed broadly to include configurations having any number of component-types/elements that provide LUT-FF functionality.

The number of CIPs (Configurable Interconnection Points) in a 3-D switch 104b is larger than that of 2-D switch. If there are m wires per channel, there are 15m CIPs in a disjoint switch since there are six sides in a regular hexahedron and each wire can be connected to the other five wires on the other five sides. Therefore, six wires on six sides are connected to the other five wires on the other five sides but each connection is counted twice. Thus, the number of connections is 6*5/2=15. A disjoint switch is a switch where each wire on one side is connected to only the corresponding wire on the other side. Assume that there are n wires on one side of 3-D switch with index 0, 1, . . . n−1. In a disjoint switch, wire 0 is connected only to wire 0 on the other side, wire 1 is connected to only wire 1 on the other side and so on. If all of the n wires are connected to all other n wires on the other side, then it is called a fill-crossbar switch. A full-crossbar switch requires a relatively large number of interconnections and thus a disjoint switch is typically used.

Pins of the PLB are connected to wires. In an exemplary embodiment, if there are p pins in a slice and each pin is connected to q wires in 3-D switch, there are npq connections. The number of CIPs in a switch for pq connections is log2(npq).

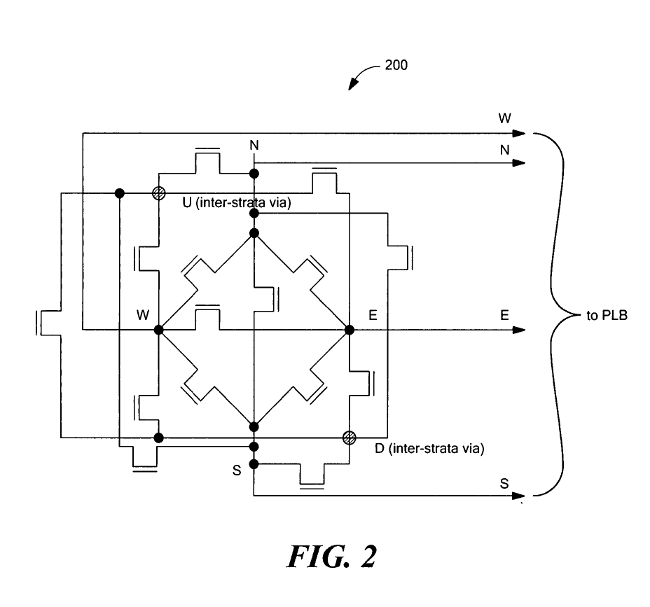

FIG. 2 shows an exemplary 3-D switch structure 200 for a single wire on a stratum. The six wire connections for the switch pins can be considered, for ease of description without limiting the invention, as North (N), South (S), East (E), West (W), Up (U), and Down (D). Wire connections N, W, S, and E are intra-stratum wire connections. Up (U) and Down (D) vias are inter-stratum vias. Wire connections N, W, S and E are connected to PLB pins and inter-layer vias U, D are not connected to the PLB. Inter-layer vias U, D are used for interconnection among physical wires.

While an exemplary switch structure is shown in the illustrated embodiment, modifications, substitutions and alternatives, etc. to the switch structure will be readily apparent to one of ordinary skill in the art without departing from the invention. In addition, while reference may be made to first and second inter-strata connections U, D, and/or first, second, and third strata, it is understood that a 3-D FPGA refers to a FPGA having two or more layers. In an exemplary embodiment, a 3-D FPGA includes two layers and a switch may or may not include both U and D inter-strata connections.

In another aspect of the invention, in an exemplary 3-D FPGA CAD (Computer Aided Design) flow, a HDL (Hardware Description Language) netlist is synthesized and mapped into slices. HDL systems and techniques for describing FPGAs are well known to one of ordinary skill in the art. Using a CAD system, slices in tiles are located in 3-D space after consideration of wire-length, speed, and power consumption. 3-D routing assigns a set of physical wires in 3-D switches to each net. 3-D placement and routing plays a role in determining the performance of 3-D FPGAs.

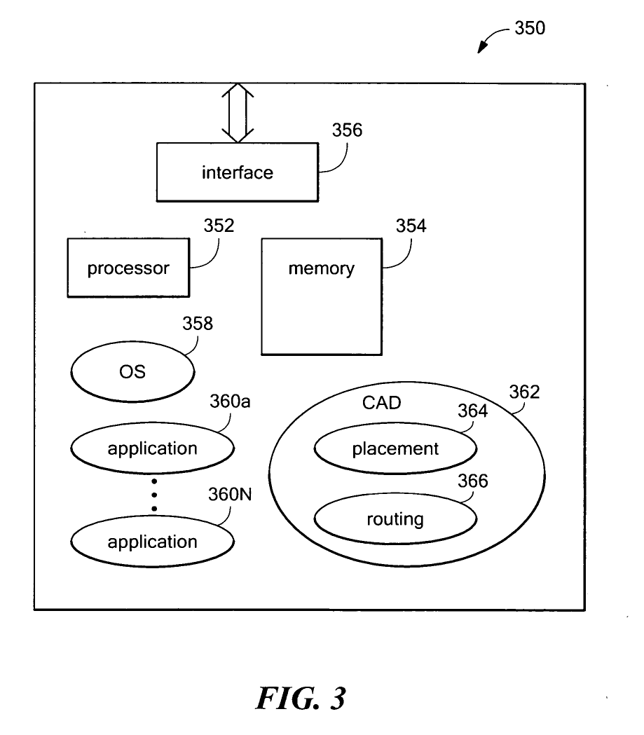

FIG. 3 shows an exemplary CAD system 350 that can be used to provide a design for a 3-D FPGA. The CAD system includes a processor 352 coupled to memory 354 and an interface 356 for enabling the system to communicate over a network and to other devices. An operating system 358 runs under which a series of applications 360a-N can operate. A CAD application 362 includes a placement module 364 and a routing module 366. Further illustrative CAD modules can include diagnostics, performance evaluation, and display, for example. Computers, workstations, and operating systems suitable for use in conjunction with the inventive CAD application will be readily apparent to one of ordinary skill in the art.

The wire-length of a net is defined as the sum of lengths of physical wires assigned to the net after placement and routing. As used herein, a net refers to a logical connection interconnecting ports of a PLB in a FPGA. There are many logical blocks (instances) in a circuit. Nets are logical connections that connect each port of the logical block to the other ports of other blocks. Routing determines the assignment of physical wires to a net and placement determines the physical location of logical blocks. A net is a logical connection describing port-to-port connections among logical blocks. Routing assigns a set of physical wires to a net such that signals are transferred through physical wires.

It will be appreciated that the inventive 3-D FPGA configuration reduces total wire-length and improves the operating speed of the circuit by reducing the path length of a net that is proportional to the signal delay.

In an exemplary embodiment, a 3-D placement algorithm is based on simulated annealing. As is well known to one of ordinary skill in the art, simulated annealing is a technique that can escape local minima, and potentially discover global minima, when attempting to find an optimal solution to a given problem. Simulated annealing has been applied to placement in two-dimensional FPGAs, for example, as is well known in the art.

In exemplary embodiments of the inventive 3-D FPGA design techniques, simulated annealing includes a number of iterations, where at each iteration, an instance is randomly selected and moved to a specific location. If the cost, where cost can be determined in terms of speed, power, or other parameter of interest, or combination of parameters, decreases the movement is accepted. If the movement cost increases, the acceptance is determined by the current ‘annealing temperature.’ If the ‘temperature’ is high, the probability of acceptance is high and it is probable that the movement is accepted. If the temperature is low, the probability of acceptance low. In general, instances are moved to a specific location to minimize the cost.

In the initial stage of simulated annealing, the instances are randomly selected and moved to a random location. This random movement is repeated many times. The variance of cost is set as an initial temperature. In each iteration, the temperature is computed as follows: Tnew=Tcurrent×α, where the acceptance ratio α is less than 1.0. The decision for movement acceptance is decided as follows: R=random value between 0 and 1, if r<e^{(-cost gain/temperature)} then it is accepted. As the temperature goes down, e^{(-cost gain/temperature)} becomes smaller and the probability of acceptance ratio goes down. Otherwise, the slice movement is not accepted. The temperature decreases at each iteration and lower temperature forces slice movement with higher cost gain to be accepted.

In an exemplary embodiment, 3-D placement includes 3-D simulated annealing with two-phase slice movement: inter-strata optimization and intra-stratum optimization phase. In the inter-strata optimization phase, simulated annealing tries to move slices by computing forces near the selected slice.

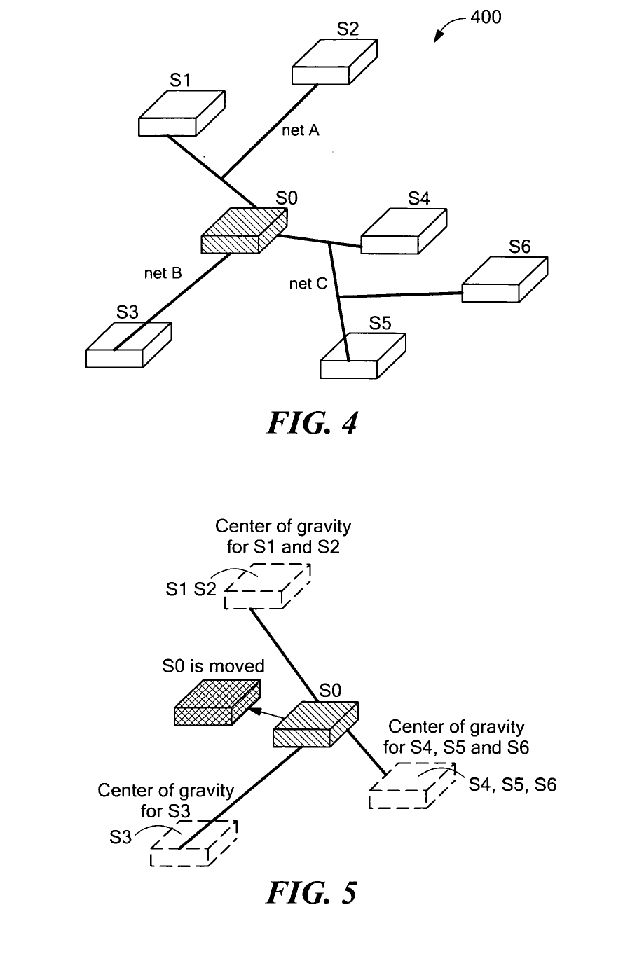

FIG. 4 shows an illustrative inter-strata optimization phase including simulated annealing attempting to move slices by computing forces near the selected slice. The force of a slice on the selected slice is can be defined as: (distance between two slices)×(weight of a net connecting those two slices). In an exemplary embodiment, the weight is timing criticality of a net. It is understood that a variety of factors other than timing criticality can be used to determine a weight.

Slice S0 is the selected instance during simulated annealing in the illustrated embodiment. Three nets, A, B, C are connected to instance S0. For each net, there are several connected slices, as shown. Net A is connected to slices S1 and S2, net B is connected to slice S3, and net C is connected to slices S4, S5, and S6. The ‘location vector’ of S0 is the 3-D vector to the location where slice S0 is located.

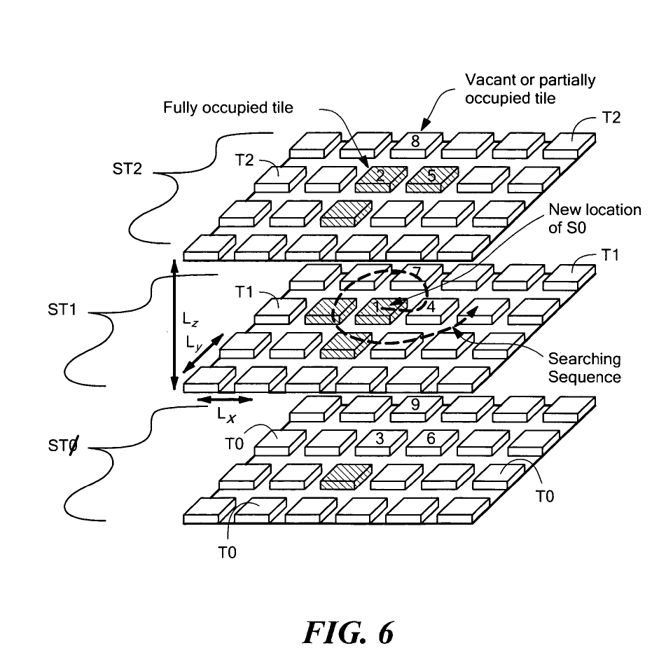

As shown in FIG. 5, the center of gravity for slices connected to each net except S0 is computed and represented as dotted boxes. For example, slices S1, S2 are connected to net A and the dotted box S1S2 represents the center of gravity of slices S1 and S2. For each net, there are several slices connected by the same net. The center of gravity is the weighted average of the locations of slices. In one embodiment, each slice has the same weight. The force of each net on S0 is the location difference vector between S0 and the center of gravity of each net. The sum of the location difference vectors is the new location vector of S0. This relationship is defined below in Equation (1):

$${{v}^{->}}_{i}^{e} = {{v}^{->}}_{i} + {\sum }_{{n}_{k} ∈ {N}_{i}} crit ( {n}_{k} ) ( {\sum }_{j ∈ I ( {n}_{k} ) , j \neq i} {{v}^{->}}_{j} / ( \vert I ( {n}_{k} ) \vert - 1 ) - {{v}^{->}}_{i} ) / \vert {N}_{i} \vert$$

where vᵢ is the vector of the instance with index i, Nᵢ is a set of nets that are connected to instance i, nₖ is one of the nets in Nᵢ, and I(nₖ) is a set of indices of instances which are connected to nₖ. The term on the right side computes the weighted sum of the location vector difference for the current instance i.

In general, the tile locations of the inventive 3-D FPGA are discrete so that the ‘new’ location for S0 may not be available, i.e., the tile at the new location is fully occupied by other slices. In an exemplary embodiment, the location of an instance is an integer value larger than or equal to 0, not a floating-point value—discrete indicates that a location is an integer value. If a new location is not available, the system searches around the new location for an available tile.

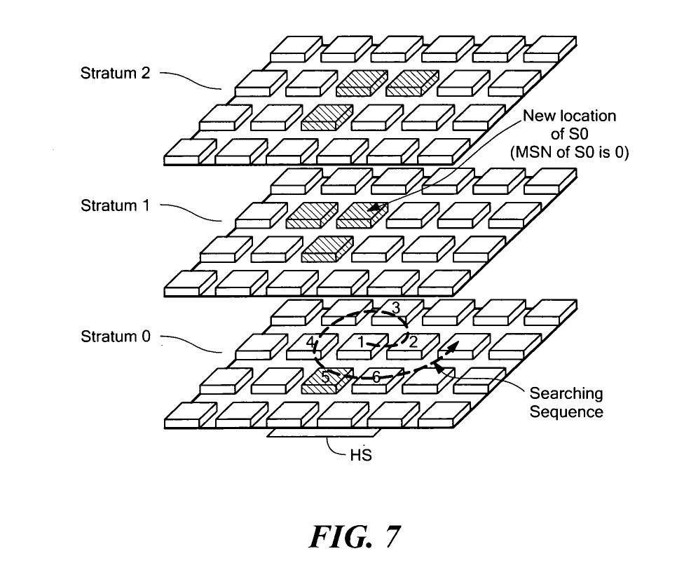

FIG. 6 shows an exemplary available location search around S0. First, second, and third strata ST0, ST1, ST2 are shown, each having a series of tiles T0 (stratum ST0), T1 (stratum ST1), T2 (stratum ST2). Locations are defined along first, second and third coordinate axes Lx, Ly, Lz.

In one embodiment, the system searches around the new location S0 in a spiral direction. The search sequence is enumerated by the numbers on the tiles, e.g, 1, 2, . . . , 9 as shown on each strata ST1, ST2, ST3. At each candidate location, the system attempts to find an available location at a different strata with the same x and y location (but different z location). Reasons for searching an available location at different strata include that the number of strata (e.g., 2˜4) will be typically be smaller than that of rows and columns in each stratum (e.g., ˜100). If the original location of S0 is relatively far from the new location of S0 and the cost gain, as defined for the selected parameter(s) is relatively large, it is better in speed and wire-length to find an available location just above or below of the new location than searching for another location in the spiral direction that is farther from the new location. In addition, the distance between strata, Lz (˜50 μm) is typically smaller than intra-strata distance (e.g., Lx or Ly ˜500 μm) although the delay through the inter-strata via (U, D in FIG. 2) depends upon the process technology. If the process technology allows the diameter of the inter-strata via (e.g., U, D in FIG. 2) to be relatively small with low capacitance, the delay through inter-layer via will likely be smaller than a relatively long wire between tiles in a stratum. As each instance moves to equilibrium position, instances are located in different strata reducing overall cost.

In another aspect of the invention, after multiple iterations of the inter-stratum phase described above, instances tend to equilibrium locations. An acceptance ratio α, i.e., the percentage of movements accepted for each iteration, becomes under a certain level. If the acceptance ratio α is under a predetermined threshold γ, intra-stratum optimization begins. In the intra-stratum optimization phase, instances are permitted to move only in the same stratum with local optimization in each stratum.

In general, 3-D routing is based on negotiated-cost global routing with advanced 3-D wavefront expansion. In one embodiment, the routing algorithm operates as follows. For each net, the router searches for a wavefront including ports of the net. The router includes a driver port that drives the value of the net. It iteratively includes nearby physical wires in the wavefront. If all ports of the net are included then the wavefront expansion stops. If one looks at the wavefront, there are many possible paths that connect all the ports. Then so-called backtracing starts from each port and selects physical wires to meet the driver port. Initially, 3-D routing performs breadth-first searching to enumerate paths and compute timing criticality for the paths. Assume there is a tree structure with P as a parent, A, B, and C are children of A. A0, A1, and A2 are children of A and so on. In breadth-first searching, the algorithm searches nodes as follows P->A->B->C->A0->A1->A2->B0->B1->B2 . . . . The other depth-first searching searches nodes as follows. P->A->A0->A1->A2->B->B0->B1->B2 . . . ].

For each net, wavefront expansion around a driver pin of the net searches possible routing paths and, after determining that wavefront meets the load pins, backtracing determines lowest-cost routing path for each net. The number of overused wires decreases by the cost-based negotiation between nets as the routing of all nets is iterated. During the routing, a physical wire can be occupied by several nets so that it is considered overused. That is, an ‘overused’ physical wire is occupied by several nets temporarily during the routing process. As iterations progress, a physical wire becomes occupied by only a single net.

It should be noted that heat removal capability may deteriorate in a 3-D FPGA as multiple strata are integrated. In vertically integrated 3-D FPGAs with a heat sink on the package, the strata not in contact with a heat sink may have relatively limited heat removal capability. The temperature increase on strata farther from a heat sink may have an impact on leakage power consumption as well as device reliability since the leakage power has an exponential dependency on temperature. Typically, wires and switches of FPGAs are responsible for significant power consumption in FPGAs. The switching power of FPGAs is reduced by allocating a smaller number of physical wires to a net with higher switching activity. The leakage power in 3-D FPGA is a consideration due to temperature increases caused by vertical transistor stacking.

In an exemplary embodiment, a 3-D FPGA has a heat sink at the printed circuit board (PCB), i.e., the bottom stratum is in contact with a heat sink. It may be efficient to allocate wires going through 3-D switches at lower strata to a net with higher switching activity to decrease temperature on each stratum in the 3-D FPGA. In other words, it reduces leakage power consumption to locate instances connected to a net with higher switching activity in a lower stratum because the router typically allocates wires that go through 3-D switches located between the maximum stratum number and the minimum stratum number of instances connected to the net. Energy driven 3-D placement locates slices connected to the net with higher switching activity at lower strata.

Initially, the “power criticality” of each slice is initialized. The normalized switching activity of each net is added to the power criticality of slices connected to the net. In an exemplary embodiment, the slices are sorted according to the power criticality and each slice is assigned “max. stratum number (MSN)”. The slices having higher power criticality are assigned a lower MSN where the stratum in contact with a heat sink has stratum number of 0, for example.

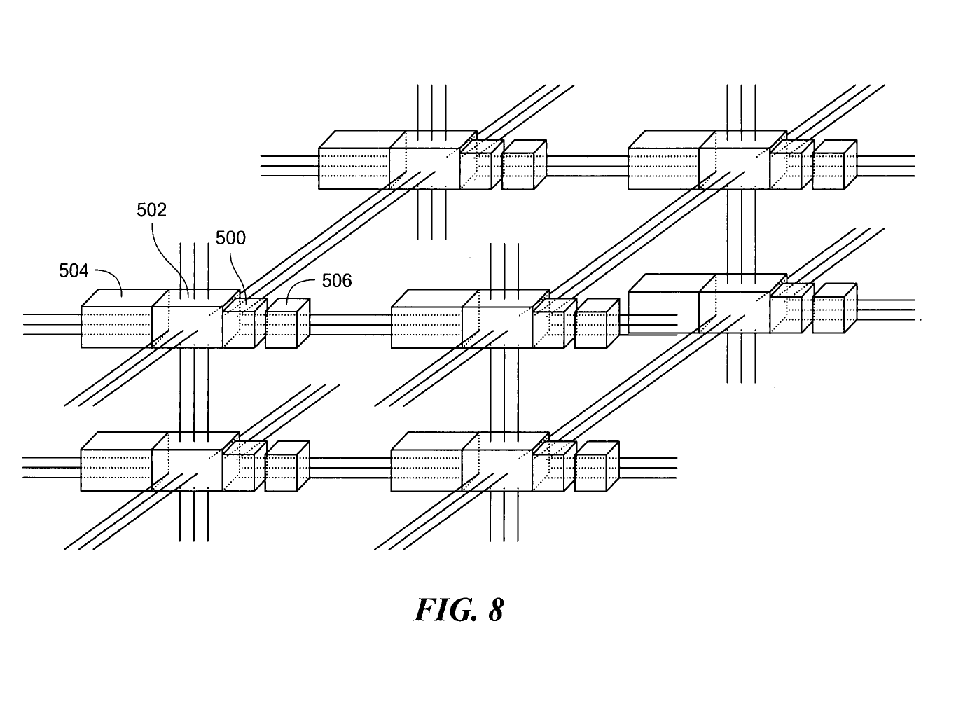

FIG. 7 shows an exemplary available location search in power driven 3-D placement, where a heat sink HS is located proximate stratum 0. The MSN of the new location of S0 is 0, i.e., S0 has higher power criticality. The location search is limited to stratum 0 but the limit on the stratum number is relaxed as the system cannot find an available location within the predetermined aperture.

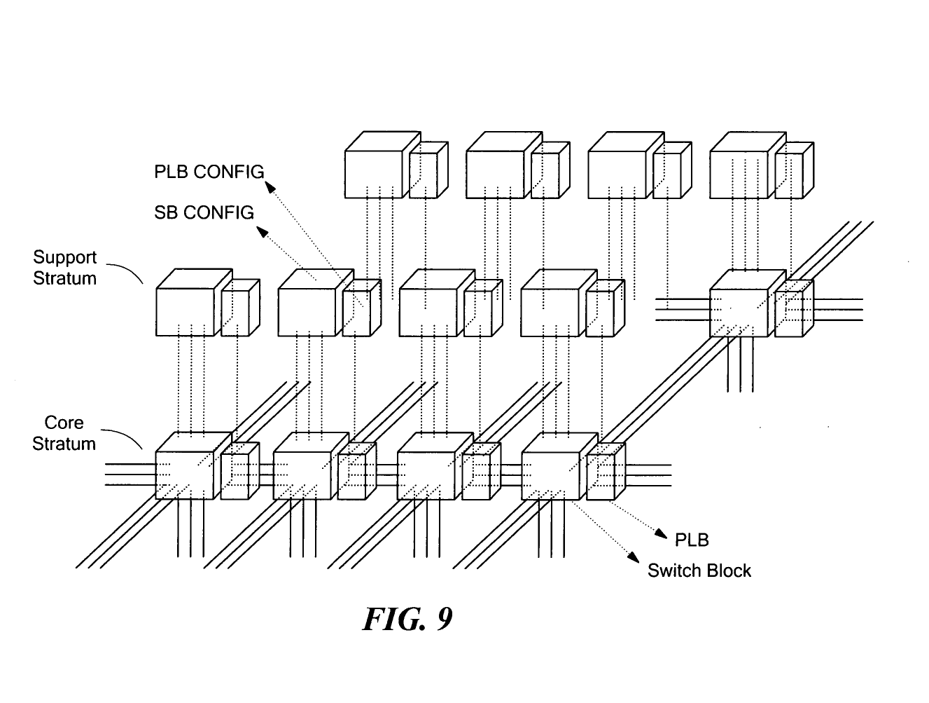

In another aspect of the invention shown in FIG. 8, a 3-D FPGA design can be partitioned across the various strata. The elements for one tile (PLB 500, switches 502, and switching block configuration memory 504, and PLB configuration memory 506) are collocated and wires between switches in the vertical direction cross between strata.

In order to shorten the wire-lengths among the core logic and routing area, it is beneficial to locate configuration memory, here shown as SB config and PLB config, and other peripheral elements to a different stratum. The stratum with the logic blocks, here shown as PLB and switch block, and routing switches is the “core stratum” and the stratum with configuration memory and other non-essential items is the “support stratum.”

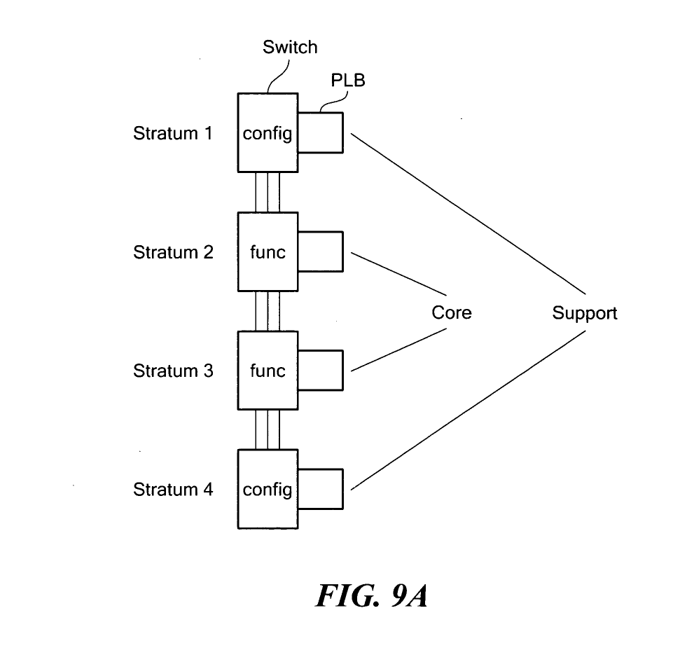

With this separation, the configuration information is delivered via the inter-strata vias, as shown in the exemplary partition in FIG. 9. In the case of more than two strata, this partitioning can still benefit from small delay of cells in different strata by alternating core and support strata such that core strata are adjacent to each other.

For example as shown in FIG. 9A, while stratum 1 is devoted to support and stratum 2 is devoted to core functional cells, stratum 3 can be devoted to core functional cells and stratum 4 to support. As a result, the connection between functional blocks in strata 2 and 3 has a relatively short delay.

An additional advantage of using support strata for configuration memory is the ability to use a different process technology for these elements. The support layer can be designed in a first memory process tuned for low leakage power while the core layer can be designed in a second process for high performance logic.

In another embodiment, 3-D partitioning places pipelining registers that are in the switch block on a separate layer. Again, this technique reduces the area overhead of supporting interconnect pipelining by reducing the number of gates in the core layer.

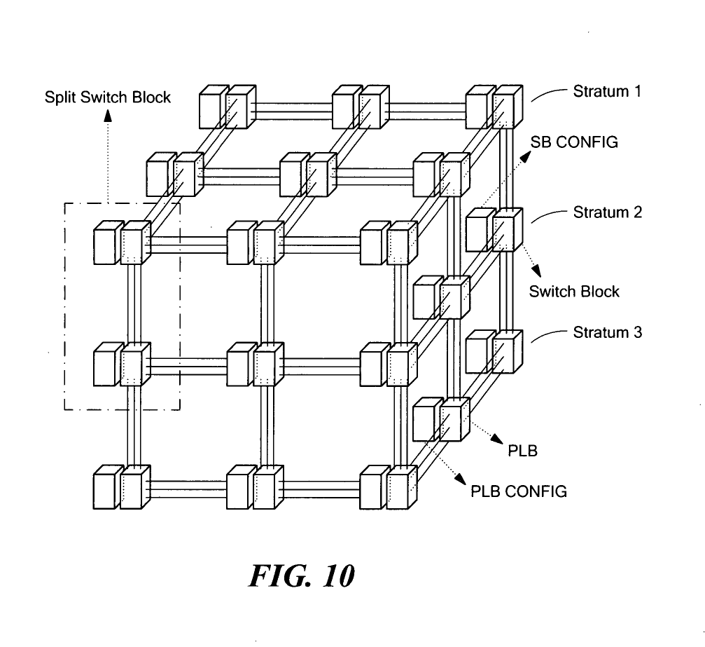

FIG. 10 shows another partitioned architecture placing PLBs in one stratum (stratum 3) and switch blocks on another strata (stratum 2). In physical partitioning, it is desirable to keep the number of inter-strata connections to a relatively small number since they are expensive in terms of area. Switch blocks have relatively few input/output ports, but the size of the block is on the large side. Placing the switch blocks in separate strata brings tiles close to each other. This partitioning makes it feasible to implement a more complex switch block since the area of the switch block will increase in the third dimension and does not degrade speed. It also allows more horizontal connections since horizontal connections are made in two strata.

The support strata can be used for the distribution of power. In a distributed power domain design, power switches, which can require significant area, are placed on a support layer and the power rails are supplied by inter-strata vias. The distributed power switches can be independently controlled to provide the optimal voltage level for a particular tile or to greatly reduce current leakage in an unused tile.

The support strata can contain analog components such as Analog-to-Digital Converters (ADC) or Phase-Locked Loops (PLL), which could benefit from use of a different process technology. This partitioning also improves manufacturability as the support layer can be tested separately from the core layer.

Other embodiments are within the scope of the following claims.

What is claimed is:

1. A method, comprising:
connecting a first switch of a first tile in an array of FPGA tiles having first and second strata, wherein the first tile is located on the first strata, to a second switch of a second tile on the second strata.

2. The method according to claim 1, wherein the first switch is connectable to at least five adjacent switches, four of which are located on the first strata.

3. The method according to claim 1, further including coupling the first switch to the second switch using an inter-strata via.

4. The method according to claim 1, wherein a structure for a first wire of the first switch includes four intra-stratum connections and at least one inter-strata connections.

5. The method according to claim 1, further including reducing wire-length as parameter to route and place components in the FPGA.

6. The method according to claim 5, further including using simulated annealing to place slices.

7. The method according to claim 1, further including performing intra-strata optimization.

8. The method according to claim 7, further including using a center of gravity for slices coupled to a net coupled to a selected instance of a slice.

9. The method according to claim 7, further including performing an available location search in an inter-strata spiral.

10. The method according to claim 1, further including performing power-driven placement.

11. The method according to claim 10, further including locating instances having a higher switching activity on a strata close to a heat sink.

12. The method according to claim 1, further including partitioning the FPGA to collocate elements for a tile including a PLB, switch, and configuration memory.

13. The method according to claim 1, further including partitioning the FPGA to alternate support strata and core strata.

14. The method according to claim 1, further including partitioning the FPGA to place PLBs on the first strata and switch blocks on the second strata.

15. An FPGA device, comprising:
a three dimensional (3-D) array of tiles each having a 3-D switch and a PLB, wherein a first one of the switches in the array of tiles can be coupled to at least five other ones of the switches in the array of tiles across at least first and second strata.

16. The device according to claim 15, wherein the first one of the switches includes a number of configurable interconnection points (CIPs) equal to fifteen times the number of wires per channel.

17. The device according to claim 15, wherein pins of the PLB are connected to wires, wherein a structure for a wire connection includes four intra-stratum connections and at least one inter-stratum connections.

18. The device according to claim 1, wherein the FPGA is partitioned.

19. The device according to claim 18, wherein the FPGA is partitioned based upon one or more of tile element collocation, support and core stratum, PLB stratum and switch stratum, and alternating stratum.

20. A CAD system, comprising:
a processor;
a memory coupled to the processor, the memory having stored instructions that when executed enable:
connecting a first switch of a first tile in an array of FPGA tiles having at least first and second strata, wherein the first tile is located on the first strata, to a second switch of a second tile on the second strata.

21. The system according to claim 21, further including instructions for reducing wire-length as parameter to route and place components in the FPGA.

22. The system according to claim 21, further including instructions for performing intra-strata optimization.

23. The system according to claim 16, further including instructions for performing power-driven placement.
